(19) United States
(12) Patent Application Publication
(10) Pub. No.: US 2020/0068455 A1
(43) Pub. Date: Feb. 27, 2020

(54) WIRELESS DEVICE HANDOVER

(71) Applicant: Intel IP Corporation, Santa Clara, CA (US)

(72) Inventors: Biljana Badic, Munich (DE); Zhibin Yu, Unterhaching (DE); Markus Dominik Mueck, Unterhaching (DE); Bernhard Raaf, Neuried (DE); Christian Drewes, Germering (DE); Dave Cavalcanti, Portland, OR (US); Ana Lucia A. Pinheiro, Hillsboro, OR (US); Nageen Himayat, Fremont, CA (US); Ranganadh Karella, San Diego, CA (US)

(21) Appl. No.: 16/487,657

(22) PCT Filed: Mar. 31, 2017
(86) PCT No.: PCT/US2017/025425

§ 371 Date: Aug. 21, 2019

(51) Int. Cl. H04W 36/00; H04W 88/06; H04W 48/16; H04W 36/08; H04W 4/029

(52) U.S. Cl. CPC H04W 36/0061; H04W 88/06; H04W 4/029; H04W 36/08; H04W 48/16

(57) ABSTRACT

A wireless device having a receiver configured to receive, from a second wireless device, information about one or more infrastructure devices having respective coverage areas in which the second wireless device traveled, wherein the information comprises time stamp information and geographical information of the second wireless device when the information was observed; and a processor configured to process the information of the one or more infrastructure devices to determine to which of the infrastructure devices the wireless device is to be handed over.

### BACKGROUND

The automotive industry is undergoing technological transformations as vehicles become more connected to the Internet and to each other. In order to deal with increasingly complex road situations, automated vehicles need to rely not only on their own sensors, but also information communicated from other automated vehicles.

Vehicle-to-Everything (V2X) communication is the passing of information from a vehicle to any entity that may affect the vehicle, and vice versa. V2X is a vehicular communication system that incorporates other more specific types of communication, such as Vehicle-to-Infrastructure (V2I), Vehicle-to-Vehicle (V2V), Vehicle-to-Device (V2D), etc. V2X is used as an example type of communication for purposes of explanation, but the disclosure is not limited in this respect.

Currently there are two types of technologies that support V2X communications: Dedicated Short Range Communications (DSRC) and cellular technologies. DSRC is a standard protocol for vehicular communication. Regarding cellular technologies, 3rd Generation Partnership Project (3GPP) Long Term Evolution (LTE) V2V/V2X is a candidate for 5th Generation (5G) wireless systems. DSRC and 3GPP LTE V2V/V2X differ substantially. For example, spectrum access is managed differently, that is, DSRC uses contention based access, whereas 3GPP LTE V2V/V2X manages scheduling based on efficient use of resources. At the same time, 3GPP has introduced standard enhancements to support Internet of Things (IoT) applications, which extend cellular coverage using data connections with the network in remote and poor network access areas, such as underground parking, rural areas, and cell edges.

DSRC and cellular technologies face deployment challenges. DSRC has limited communication range (150 m-300 m), and cellular coverage is not always available (rural areas, underground, tunnel, loaded cell). Therefore, a single technology is not sufficient to support a variety of expected V2X applications for a large number of vehicles. Also, future ultra-dense network deployments with smaller base station ranges require frequent handovers. In such a dynamic environment, V2X communication and autonomous driving requires effective and accurate handover techniques and network selection schemes.

### BRIEF DESCRIPTION OF THE DRAWINGS

FIG. 1 illustrates a wireless communication system in accordance with aspects of the disclosure.

FIG. 2 illustrates a wireless device in accordance with aspects of the disclosure.

FIG. 3 illustrates wireless communication system including a central technology trigger device in accordance with aspects of the disclosure.

FIG. 4 illustrates a flowchart of a method of performing wireless communication by a wireless communication device in accordance with an aspect of the disclosure.

### DESCRIPTION OF THE ASPECTS

The present disclosure is directed to wireless device-centric and network-centric handover strategies involving sharing information about infrastructure devices (e.g., base stations or road side units) between wireless devices to enable fast and accurate handovers. Also, a technology trigger device provides efficient handover by collecting wireless device data and selecting a radio access technology.

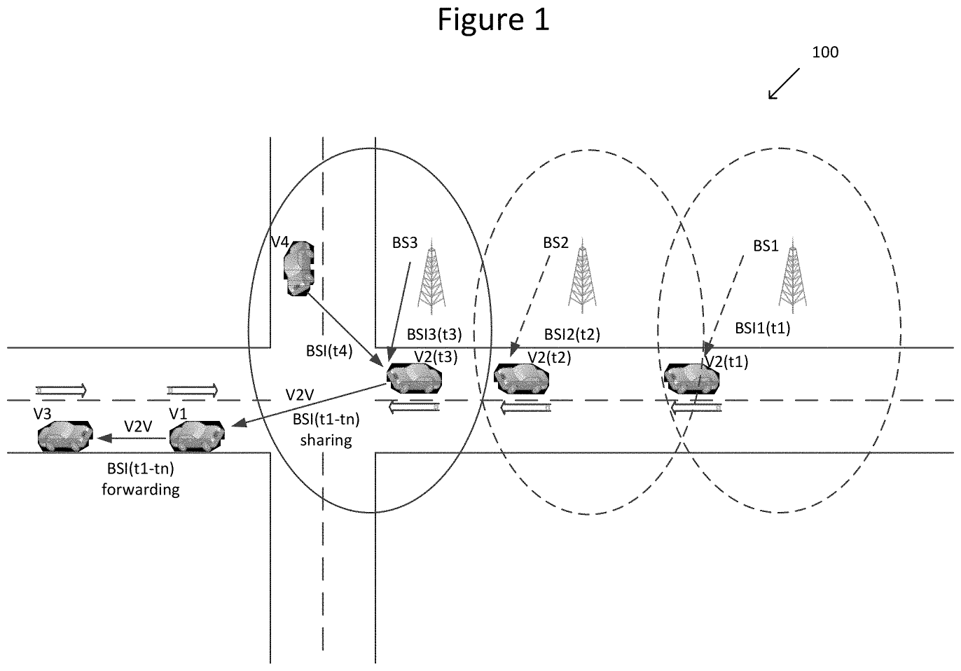

FIG. 1 illustrates a wireless communication system 100 in accordance with aspects of the disclosure.

The wireless communication system 100 comprises, in this exemplary aspect, vehicles V1-V4 and base stations BS1-BS3. The vehicle V2 is traveling (right-to-left) past three base stations BS1, BS2, and BS3 toward an intersection; the three versions of vehicle V2 represent the vehicle V2 at different points in time, t1-t3, respectively. Further, vehicle V1, and vehicle V3 following vehicle V1, are traveling (left-to-right) towards the intersection in a direction opposite that of vehicle V2. Vehicle V4 is traveling (top-to-bottom) towards the same intersection, but in a direction orthogonal to those of the vehicles V1-V3.

The following description sometimes refers to vehicles and wireless devices interchangeably because the wireless device may be located within a vehicle. The wireless device may additionally be located elsewhere, such as in a base station (BS), a Road Side Unit (RSU), or other structure in a case of alternative technological applications. Types of wireless devices include autonomous devices, Internet Of Things (IOT) devices, drones, mobile phones etc., and these devices may also employ the handover strategies without departing the spirit and scope of the present disclosure.

A handover procedure of the vehicles Vs in accordance with aspects of the disclosure may comprise the following Steps 1-4.

Step 1: Base Station Information (BSI) Tracking and Storing

The wireless device of vehicle V2 may track and store information about base stations BSs vehicle V2 passes. More specifically, the wireless device of vehicle V2 may receive, from each of the base stations BS1, BS2, and BS3 it passes, base station information BSI1(t1), BSI2(t2), and BSI3(t3), respectively, at respective times t1-t3. It is also possible that vehicle V2 receives base station information BSI from a same base station and two different points in time, such as when the vehicle V2 both enters and exits a cell coverage area of the base station BS.

The ovals around the base stations BS1, BS2, and BS3 represent cell coverage areas, with the dotted ovals representing vehicle V2's prior cell coverage and the solid oval representing its current cell coverage. Vehicle V2 is also shown receiving, from vehicle V4, V4's collected base station information BSI(t4).

Step 2: Base Station Information (BSI) Sharing

The wireless device of vehicle V2 may share the information about the base stations BSI with the wireless devices of other vehicles, such as vehicle V1, using coordinated communication, such as V2V.

More specifically, the wireless device of vehicle V1 receives, from the wireless device of vehicle V2, the information about any base stations BSI corresponding to respective base stations BSs. This sharing may occur when a distance between the wireless devices of vehicles V1 and V2 is less than a predetermined distance, which may be the distance that is the distance limit of the wireless technology, such as DSRC.

The information about the base stations BSI may comprise time stamp information and geographical information of the vehicle V at the time the information was observed. The geographical information may be Global Navigation Satellite System (GNSS) information, for example, though the disclosure is not limited in this respect. The base station information BSI may also comprise respective Received Signal Strength Indicator (RSSI) measurements and/or respective validity timers indicating times for which the RSSI measurements and/or base station information BSI are valid.

Step 3: Base Station Information (BSI) Utilization

The wireless device of vehicle V1 may use the shared base station information BSI to predict base stations BSs it may pass and prepare for a fast handover.

More specifically, the wireless device of vehicle V1 may process the base station information BSI to determine to which of the corresponding base stations BSs the vehicle V1 is to be handed over. Also, the wireless device of vehicle V1 may compare navigation path planning information with the geographical information to predict one or more base stations BSs to which the wireless device of the vehicle V1 is to be handed over. This prediction may start at the time of a planned trip when the route is set, which will result in a certain accuracy. As the vehicle, such as an autonomous vehicle, starts the route, the prediction may be continuously updated using base station information BSI from wireless devices of other vehicles and/or network infrastructure (i.e., BSs and RSUs).

The wireless device of vehicle V1 may alternatively or additionally process the information of the base stations BSI to determine to which beam of a same base station BS the vehicle V1 is to be handed over. More specifically, the handover, rather than being a base station handover, may be a beam handover to a beam within the same base station. In such a scenario, the beam selected for handover may not be the strongest beam, but may instead be the best beam, such as one that is more persistent as opposed to short-lived.

Base station measurements are time consuming because before quality/signal strength measurements are performed, preprocessing search steps must be performed. Also, base station search areas are generally large. By using the shared base station information BSI, as disclosed herein, search areas may be significantly reduced. More specifically, the preprocessing search steps involving base station offset blind detection, coarse frequency offset blind detection, and cell identification blind detection, Evolved Universal Terrestrial Radio Access (EUTRA) Absolute Radio Frequency Channel Number (EARFCN), and base station identification, which may be included in the base station information BSI, may be shared in advance, thereby reducing the time for preprocessing search steps.

Furthermore, the base station quality/strength measurement step itself is time consuming because the wireless device of the vehicle V applies filtering algorithms for each candidate base station BS detected during the preprocessing (BS search) steps. The time linearly scales with the number of candidate base stations. By using incoming base station BS prediction as mentioned above, the candidate base stations BS are pre-filtered, and the measurement time is reduced. Handover performance in a fast driving scenario is thereby improved.

Depending on the intended (or actually driven route), vehicle V1 will either use the information about the base stations BSI1, BSI2, and BSI3 obtained from vehicle V2 directly (when continuing straight through the intersection) or the information about the base station BSI4 obtained from vehicle V4 via vehicle V2 (when turning left at the intersection), making use of the associated geographic information.

Step 4: Base Station Information (BSI) Forwarding

The wireless device of vehicle V1 may forward the observed base station information BSI to the wireless device of vehicle V3. The forwarded base station information BSI may be the base station information BSI1-BSI3 observed by the wireless device of vehicle V2. This forwarding of the base station information BSI may be prompted by a request received by the wireless device of vehicle V1 from the wireless device of the vehicle V3. Optionally, this request could be for a subset of the base station information BSI.

Aggregation of the base station information BSI is possible. Rather than forwarding only the base station information BSI a wireless device of a vehicle V2 observes itself, the wireless device of the vehicle V2 may also forward base station information BSI it has received from wireless devices of other vehicles, such as vehicle V4. This makes the base station information BSI more comprehensive for the receiving vehicle V1, as the information covers more routes which the vehicle V1 may take. The wireless device of vehicle V2 may not need to pass on all of the base station information BSI related to all routes of the wireless device of vehicle V1, but vehicle V1 may instead request base station information BSI for a specific route, and the wireless device of vehicle V2 may then forward the relevant subset of base station information BSI. In one embodiment, the forwarding may include adding the base station information BSI to a broadcast message, such as a basic safety message.

Data privacy may be a concern for some applications. When a wireless device of vehicle V2 forwards base station information BSI of only its own path, vehicle V2 will implicitly disclose to vehicle V1 the path vehicle V2 has taken. However, when forwarding both base station information BSI of its own path and paths taken by other vehicles (in this example, vehicle V4), vehicle V2 effectively hides its own path, as now vehicle V1 cannot know whether vehicle V2 traveling via its own path or the path traveled by vehicle V4. This may be an easy measure to conceal private information from other vehicles. The more paths are aggregated in the forwarded base station information BSI, the more efficient the concealment is, and also the more comprehensive and useful the information is for the receiving vehicle. In a case of forwarding the base station information BSI via a BS or RSU, it is even less likely a wireless device of a receiving vehicle V will be able to associate forwarded base station information BSI with a particular vehicle V.

Optionally, a wireless device of a vehicle V may forward the base station information BSI to a plurality of wireless devices for a group handover determination. This forwarding may be performed using a broadcasting/multicasting scheme in predetermined time periodicities, or using a peer-to-peer scheme at the request of another vehicle V.

The forwarding of the base station information BSI may be performed between vehicles or devices. Alternatively or additionally, the forwarding may be performed with infrastructure devices, for example, via an RSU which is typically situated at an intersection, or via a base station BS.

The wireless devices of the vehicles V receiving messages from other wireless devices, such as those within vehicles, RSUs or base stations, may eventually learn the identifications of base stations BS in a route and their respective locations, or approximate locations of base station boundaries. If the vehicle V takes the same route repeatedly, then handovers can be optimized for that route. This means the vehicle V will know in advance which base stations BSs it has to measure based on the vehicle's current location.

As another option, each vehicle V can report the identification of a base station BS when that vehicle V is triggered for a handover. For example, vehicle V1 may be triggered to handover to base station BSn at location A. On the other hand, vehicle V2 may be triggered to handover to the same base station BSn at location B, as this vehicle V2 may be coming from a different direction. Thus, vehicles would have information such as: BSn at location A, and BSn at location B. After receiving a plurality of base station information BSI, the vehicles V can form a database with approximate physical locations of given base stations BS, or at least some reasonable information about base station cell boundaries. This way, even if a given vehicle V does not know its complete route, the vehicle V can use its own location and have an estimate of the proximity of base stations BS based on the base station information BSI previously received by other vehicles V.

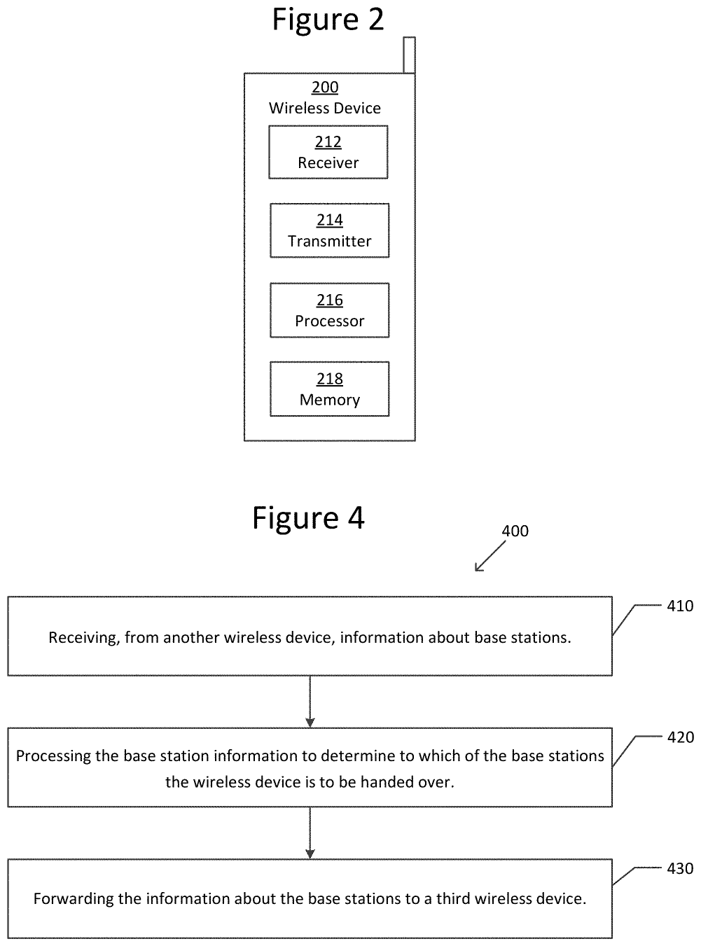

FIG. 2 illustrates a wireless device 200 in accordance with aspects of the disclosure. The wireless device 200 may be located in a vehicle V, base station BS, or Road Side Unit (RSU). The wireless device 200 may comprise a receiver 212, a transmitter 214, a processor 216, and a memory 218. As should be clear, the receiver 212, transmitter 214, processor 216, and memory 218 are configured to respectively receive, transmit, process, and store base station information BSI.

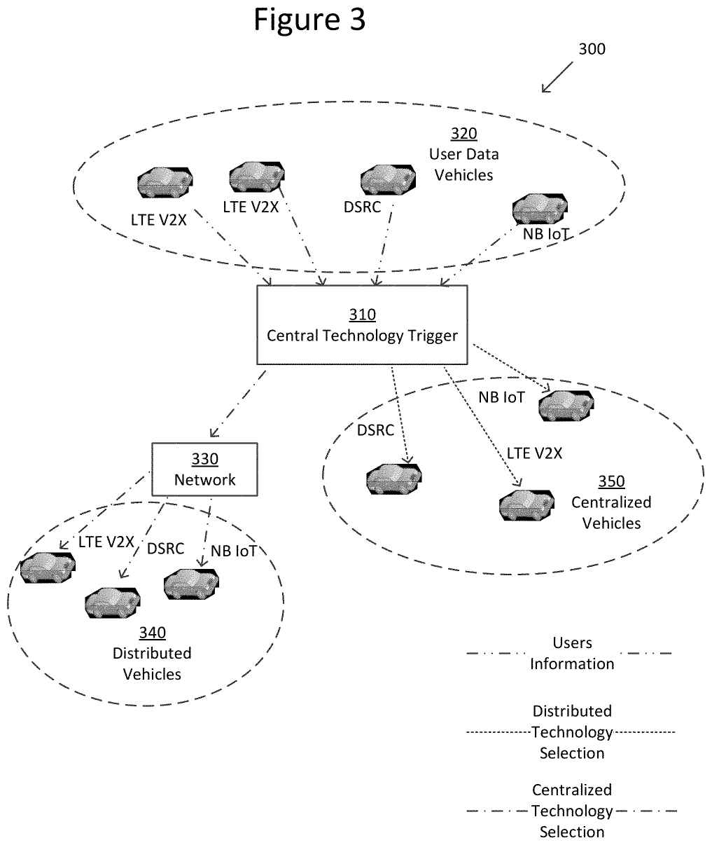

FIG. 3 illustrates wireless communication system 300 comprising a central technology trigger device 310 in accordance with aspects of the disclosure. The wireless communication system 300 also comprises user data vehicles 320, a network 330, distributed vehicles 340, and centralized vehicles 350. The vehicles 310, 320, 330 are all vehicles or devices, just formed in different groups for the purposes of explanation.

By way of overview, support fast and accurate handovers by collecting user data from wireless devices of vehicles, and then selecting which technology is best for each vehicle.

More specifically, the central technology trigger device 310 collects information (e.g., vehicle velocities, channel characteristics, radio signal measurements, coverage, locations, etc.) from user data vehicles 320. The central technology trigger device 310 then uses this collected information to determine a best technology (e.g., LTE V2X, Narrow Band IoT (NB-IoT), DSRC, Multi-Fire etc.) for each vehicle. As an example, the central technology trigger device 310 may determine that there are many dropped signals for a particular technology in a particular location, so the central technology trigger device 310 will select a different technology that is determined to be stronger in this location, and then send a trigger signal corresponding to the selected technology to the selected vehicle. The selection may be based on pre-stored user data, and/or recently measured data.

The central technology trigger device 310 may be located in a base station BS, the cloud, a server, a data center etc, and comprises a receiver, a processor, and a transmitter, similar to those described above with respect to the wireless device 200 of FIG. 2.

Further, the central technology trigger device 310 may be either centralized or distributed. In the centralized approach, the central technology trigger device 310 transmits the technology trigger signal to the wireless device of the selected vehicle 350 directly. In the distributed approach, the central technology trigger device 310 transmits the technology trigger signal to the wireless device of the selected vehicle 340 via the network 330.

The user data to be transmitted by the user data vehicles 320 to the central technology trigger device 310 may be dependent on radio and/or non-radio characteristics.

The radio characteristics may include information such as Quality of Service (QoS) metrics of specific target Radio Access Technologies (RATs) (e.g., expected throughput, Packet Error Rate (PER), etc.), coverage area of specific RATs and/or Access Points (APs), suitability of specific RATs to low/medium/high-speed users, a-priori knowledge of possible call-drops at certain areas (e.g., due to shadowing) or similar a-priori known changes of the radio characteristics (knowledge is obtained through past observations).

The non-radio characteristics may include information such as density of users (e.g., vehicle density, traffic jam, average traffic, low traffic, etc.), occurrence of a special event (e.g., accident or maintenance work which will lead to a reduction of road capacity), and location of intersections with collision avoidance service), etc.

Depending on the radio-context and non-radio-context, information provided to another wireless device may change. For example, if a road is empty or has little traffic case, minimal traffic related information needs to be provided. If abrupt changes in the radio context are known for a specific location (e.g., a known wall leads to call drops or similar), corresponding information will be provided in order to enable predictive decision making in the vehicles to avoid a loss of communication. If no such change of the radio context is expected, minimum/no corresponding information needs to be provided to the other wireless device.

FIG. 4 illustrates a flowchart 400 of a method of performing wireless communication by a wireless communication device in accordance with an aspect of the disclosure.

In Step 410, the receiver 212 of the wireless device receives, from another wireless device, information about one or more base stations BSs, or other infrastructure devices.

In Step 420, the processor 216 of the wireless communication device processes the base station information BSI to determine to which of the corresponding base stations BS the wireless device is to be handed over.

In Step 430, the transmitter 214 transmits the base station information BSI to a third wireless device.

The aspects of this disclosure have advantages over prior wireless systems. Instead of sharing only instantaneous base station parameters from one wireless device to another, the wireless devices of this disclosure share historical information on base stations BSs that have been passed. In other words, a vehicle shares a history of base stations BS visited in a form of base station information BSI in order to assist other vehicles during measurements and handover. This result is sustainable optimization for frequent inter-frequency handovers in a high-speed traffic situations.

Further, rather than using the shared base station information to immediately start blind quality measurements, this disclosure describes applying prediction algorithms in advance. The prediction is based on correlating the vehicle's path planner with geographic information from the shared base station information. As a result, pre-filtering may be performed so that only base stations BSs which are high priority handover candidates are considered, thereby reducing the search range when compared with the entire neighbor base station list. The result is a reduction in number of measurements, reduction in battery consumption, and faster handover. While battery consumption may not be an issue in the context of vehicular use, but may be a consideration in other contexts, such as asset tracking.

Network assisted/controlled handovers are also possible. Network nodes may proactively direct handover decisions for the vehicles V. For example, the vehicles V may share the destination/path information with the network (BS, RSU, etc.), which may then determine the best base station selection for the vehicle V in advance. The network may also require the vehicle V to share its speed and may schedule periodic measurement reports with specific BSs, which may assist the network in executing handovers in advance. The network, based on the handover patterns of a particular vehicle V, may also learn the likely trajectories of the vehicle V and use this information to make pro-active handover decisions. It may then schedule periodic measurements for the base stations BSs that will be in the vehicle V's predicted path and execute handovers without vehicles Vs needing to monitor an excessive number of base stations BSs. In network assisted/controlled handovers for vehicle platoons/convoys, wherein a group of vehicles are travelling together, the path of only the lead or a single vehicle may be registered with the network. Group handovers may then be executed for those vehicles V. Both, the V2V and the network assisted solutions may apply for executing group handovers.

While this disclosure is described with respect to V2X and DSRC technologies, it is understood that the disclosure is not limited to these particular technologies, or to only two technologies. Any of the radio links may operate according to any one or more of the following radio communication technologies and/or standards including but not limited to: a Global System for Mobile Communications (GSM) radio communication technology, a General Packet Radio Service (GPRS) radio communication technology, an Enhanced Data Rates for GSM Evolution (EDGE) radio communication technology, and/or a Third Generation Partnership Project (3GPP) radio communication technology, for example Universal Mobile Telecommunications System (UMTS), Freedom of Multimedia Access (FOMA), 3GPP Long Term Evolution (LTE), 3GPP Long Term Evolution Advanced (LTE Advanced), Code division multiple access 2000 (CDMA2000), Cellular Digital Packet Data (CDPD), Mobitex, Third Generation (3G), Circuit Switched Data (CSD), High-Speed Circuit-Switched Data (HSCSD), Universal Mobile Telecommunications System (Third Generation) (UMTS (3G)), Wideband Code Division Multiple Access (Universal Mobile Telecommunications System) (W-CDMA (UMTS)), High Speed Packet Access (HSPA), High-Speed Downlink Packet Access (HSDPA), High-Speed Uplink Packet Access (HSUPA), High Speed Packet Access Plus (HSPA+), Universal Mobile Telecommunications System-Time-Division Duplex (UMTS-TDD), Time Division-Code Division Multiple Access (TD-CDMA), Time Division-Synchronous Code Division Multiple Access (TD-CDMA), 3rd Generation Partnership Project Release 8 (Pre-4th Generation) (3GPP Rel. 8 (Pre-4G)), 3GPP Rel. 9 (3rd Generation Partnership Project Release 9), 3GPP Rel. 10 (3rd Generation Partnership Project Release 10) , 3GPP Rel. 11 (3rd Generation Partnership Project Release 11), 3GPP Rel. 12 (3rd Generation Partnership Project Release 12), 3GPP Rel. 13 (3rd Generation Partnership Project Release 13), 3GPP Rel. 14 (3rd Generation Partnership Project Release 14), 3GPP Rel. 15 (3rd Generation Partnership Project Release 15), 3GPP Rel. 16 (3rd Generation Partnership Project Release 16), 3GPP Rel. 17 (3rd Generation Partnership Project Release 17), 3GPP Rel. 18 (3rd Generation Partnership Project Release 18), 3GPP 5G, 3GPP LTE Extra, LTE-Advanced Pro, LTE Licensed-Assisted Access (LAA), MuLTEfire, UMTS Terrestrial Radio Access (UTRA), Evolved UMTS Terrestrial Radio Access (E-UTRA), Long Term Evolution Advanced (4th Generation) (LTE Advanced (4G)), cdmaOne (2G), Code division multiple access 2000 (Third generation) (CDMA2000 (3G)), Evolution-Data Optimized or Evolution-Data Only (EV-DO), Advanced Mobile Phone System (1st Generation) (AMPS (1G)), Total Access Communication System/Extended Total Access Communication System (TACS/ETACS), Digital AMPS (2nd Generation) (D-AMPS (2G)), Push-to-talk (PTT), Mobile Telephone System (MTS), Improved Mobile Telephone System (IMTS), Advanced Mobile Telephone System (AMTS), OLT (Norwegian for Offentlig Landmobil Telefoni, Public Land Mobile Telephony), MTD (Swedish abbreviation for Mobiltelefonisystem D, or Mobile telephony system D), Public Automated Land Mobile (Autotel/PALM), ARP (Finnish for Autoradiopuhelin, “car radio phone”), NMT (Nordic Mobile Telephony), High capacity version of NTT (Nippon Telegraph and Telephone) (Hicap), Cellular Digital Packet Data (CDPD), Mobitex, DataTAC, Integrated Digital Enhanced Network (iDEN), Personal Digital Cellular (PDC), Circuit Switched Data (CSD), Personal Handy-phone System (PHS), Wideband Integrated Digital Enhanced Network (WiDEN), iBurst, Unlicensed Mobile Access (UMA), also referred to as also referred to as 3GPP Generic Access Network, or GAN standard), Zigbee, Bluetooth®, Worldwide Interoperability for Microwave Access (WiMAX)

Wireless Gigabit Alliance (WiGig) standard, mmWave standards in general (wireless systems operating at 10-300 GHz and above such as WiGig, IEEE 802.11ad, IEEE 802.11ay, etc.), technologies operating above 300 GHz and THz bands, (3GPP/LTE based or IEEE 802.11p and other) Vehicle-to-Vehicle (V2V) and Vehicle-to-Everything (V2X) and Vehicle-to-Infrastructure (V2I), Infrastructure-to-Vehicle (I2V), Vehicle-to-Device (V2D) communication technologies, 3GPP cellular V2X, IEEE 802.11p based, DSRC (Dedicated Short Range Communications) communication systems such as Intelligent-Transport-Systems and others, etc.

The concepts can also be used in the context of any spectrum management scheme including dedicated licensed spectrum, unlicensed spectrum, (licensed) shared spectrum (such as LSA=Licensed Shared Access in 2.3-2.4 GHz, 3.4-3.6 GHz, 3.6-3.8 GHz and further frequencies and SAS=Spectrum Access System in 3.55-3.7 GHz and further frequencies). Applicable spectrum bands include IMT (International Mobile Telecommunications) spectrum (including 450-470 MHz, 790-960 MHz, 1710-2025 MHz, 2110-2200 MHz, 2300-2400 MHz, 2500-2690 MHz, 698-790 MHz, 610-790 MHz, 3400-3600 MHz, etc.). Note that some bands are limited to specific region(s) and/or countries), IMT-advanced spectrum, IMT-2020 spectrum (expected to include 3600-3800 MHz, 3.5 GHz bands, 700 MHz bands, bands within the 24.25-86 GHz range, etc.), spectrum made available under FCC's “Spectrum Frontier” 5G initiative (including 27.5-28.35 GHz, 29.1-29.25 GHz, 31-31.3 GHz, 37-38.6 GHz, 38.6-40 GHz, 42-42.5 GHz, 57-64 GHz, 71-76 GHz, 81-86 GHz and 92-94 GHz, etc.), the ITS (Intelligent Transport Systems) band of 5.9 GHz (typically 5.85-5.925 GHz) and 63-64 GHz, bands currently allocated to automotive radar applications such as 76-81 GHz, and future bands including 94-300 GHz and above. Furthermore, the scheme can be used on a secondary basis on bands such as the TV White Space bands (typically below 790 MHz) where in particular the 400 MHz and 700 MHz bands are promising candidates. Besides cellular applications, specific applications for vertical markets may be addressed such as PMSE (Program Making and Special Events), medical, health, surgery, automotive, low-latency, drones, etc. applications.

Furthermore, a hierarchical application of the scheme is possible, for example, by introducing a hierarchical prioritization of usage for different types of wireless devices (e.g., low/medium/high priority, etc.), based on a prioritized access to the spectrum, for example, with highest priority to tier-1 wireless devices, followed by tier-2, then tier-3, etc. wireless devices, etc.

The concepts can also be applied to different Single Carrier or OFDM varieties, such as CP-OFDM, SC-FDMA, SC-OFDM, filter bank-based multicarrier (FBMC), OFDMA, etc., and in particular 3GPP NR (New Radio) by allocating the OFDM carrier data bit vectors to the corresponding symbol resources.

The concepts described herein may also be applicable in enterprise settings, industrial settings (e.g., robot-to-robot), aviation (e.g., plane-to-plane, drone-to-drone) and to technologies having both contention and non-contention based protocols, such as 5G and Wi-Fi.

For the purposes of this discussion, the term “processor” or “processing means” shall be understood to be circuit(s), processor(s), logic, or a combination thereof. A processor/processing means can include a microprocessor, a digital signal processor (DSP), or other hardware processor. The processor/processing means can be “hard-coded” with instructions to perform corresponding function(s) according to aspects described herein. Alternatively, the processor/processing means can access an internal and/or external memory to retrieve instructions stored in the memory, which when executed by the processor, perform the corresponding function(s) associated with the processor/processing means, and/or one or more functions and/or operations related to the operation of a component having the processor included therein.

In one or more of the exemplary aspects described herein, the memory can be any well-known volatile and/or non-volatile memory, including, for example, read-only memory (ROM), random access memory (RAM), flash memory, a magnetic storage media, an optical disc, erasable programmable read only memory (EPROM), and programmable read only memory (PROM). The memory can be non-removable, removable, or a combination of both.

The following examples pertain to further embodiments.

Example 1 is a wireless device, comprising: a receiver configured to receive, from a second wireless device, information about one or more infrastructure devices having respective coverage areas in which the second wireless device traveled, wherein the information comprises time stamp information and geographical information of the second wireless device when the information was observed; and a processor configured to process the information of the one or more infrastructure devices to determine to which of the infrastructure devices the wireless device is to be handed over.

In Example 2, the subject matter of Example 1, further comprising: a memory configured to store the information about the one or more infrastructure devices.

In Example 3, the subject matter of Example 1, wherein the geographical information is Global Navigation Satellite System (GNSS) information.

In Example 4, the subject matter of Example 1, wherein the receiver is configured to receive the information about the one or more infrastructure devices when a distance between the wireless device and the second wireless device is less than a predetermined distance.

In Example 5, the subject matter of Example 1, wherein the information about the one or more infrastructure devices comprises cell search information comprising any of cell coarse timing offset, Evolved Universal Terrestrial Radio Access (EUTRA) Absolute Radio Frequency Channel Number (EARFCN), coarse frequency offset, and cell identification.

In Example 6, the subject matter of Example 1, wherein the information about the one or more infrastructure devices comprises information about a plurality of one or more infrastructure devices, or information at different times for at least one of the one or more infrastructure devices.

In Example 7, the subject matter of Example 1, wherein the wireless device is comprised within a vehicle.

In Example 8, the subject matter of Example 1, wherein the processor is configured to compare navigation path planning information with the geographical information to determine to which one or more infrastructure devices to which the wireless device is to be handed over.

In Example 9, the subject matter of Example 1, further comprising: a transmitter configured to forward the information about the one or more infrastructure devices to a third wireless device.

In Example 10, the subject matter of Example 1, wherein the receiver is configured to receive from a third wireless device a request to forward to the third wireless device the information about the one or more infrastructure devices.

In Example 11, the subject matter of Example 10, wherein: the request is for a subset of the information about the one or more infrastructure devices, and the transmitter is configured to forward to the third wireless device the subset.

In Example 12, the subject matter of Example 9, wherein the third wireless device is a base station or a Road Side Unit (RSU).

In Example 13, the subject matter of Example 9, wherein each of the wireless device, the second wireless device and the third wireless device is a base station or road side unit.

In Example 14, the subject matter of Example 1, further comprising: a transmitter configured to forward the information about the one or more infrastructure devices to a plurality of third wireless devices.

In Example 15, the subject matter of Example 14, wherein the transmitter is configured to forward the information about the one or more infrastructure devices to the one or more third wireless devices using a broadcasting or multicasting scheme.

In Example 16, the subject matter of Example 1, wherein the second wireless device is a base station or a Road Side Unit (RSU).

In Example 17, the subject matter of Example 1, wherein the information about the one or more infrastructure devices comprises respective validity timers indicating time(s) for which the information about the one or more infrastructure devices is valid.

In Example 18, the subject matter of Example 17, wherein the information about the one or more infrastructure devices comprises respective Received Signal Strength Indicator (RSSI) measurements.

In Example 19, the subject matter of Example 1, wherein the information about the one or more infrastructure devices was received by the second wireless device from a third wireless device.

In Example 20, the subject matter of Example 1, wherein the processor is configured to process the information about the one or more infrastructure devices to determine to which beam of a infrastructure device to handover the wireless device.

Example 21 is a method of performing wireless communication by a wireless communication device, the method comprising: receiving, by a receiver of the wireless device, from a second wireless device, information about one or more infrastructure devices having respective coverage areas in which the second wireless device has passed, wherein the information about the infrastructure devices comprises time stamp information and geographical information of the second wireless device when the information was observed; and processing, by a processor of the wireless communication device, information of the one or more infrastructure devices to determine to which of the infrastructure devices the wireless device is to be handed over.

In Example 22, the subject matter of Example 21, further comprising: forwarding, by a transmitter of the wireless communication device, the information about the one or more infrastructure devices to a third wireless device.

Example 23 is a central technology trigger device, comprising: a receiver configured to receive user data from one or more wireless devices; a processor configured to process the user data and select a radio access technology to which a selected wireless device is to use for transmission; and a transmitter configured to transmit to the selected wireless device a selection trigger signal indicating the selected radio access technology.

In Example 24, the subject matter of Example 23, wherein the central technology trigger device is located within a infrastructure device and transmits to the selected wireless device directly.

In Example 25, the subject matter of Example 24, wherein the central technology trigger device is located within a infrastructure device and transmits to the selected wireless device via an intervening network.

Example 26 is a wireless device, comprising: a receiving means for receiving, from a second wireless device, information about one or more infrastructure devices having respective coverage areas in which the second wireless device traveled, wherein the information comprises time stamp information and geographical information of the second wireless device when the information was observed; and a processing means for processing the information of the one or more infrastructure devices to determine to which of the base stations the wireless device.

In Example 27, the subject matter of Example 26, further comprising: a memory configured to store the information about the one or more infrastructure devices.

In Example 28, the subject matter of Example 26, wherein the geographical information is Global Navigation Satellite System (GNSS) information.

In Example 29, the subject matter of Example 26, wherein the receiving means for receiving the information about the one or more infrastructure devices when a distance between the wireless device and the second wireless device is less than a predetermined distance.

In Example 30, the subject matter of Example 26, wherein the information about the one or more infrastructure devices comprises cell search information comprising any of cell coarse timing offset, Evolved Universal Terrestrial Radio Access (EUTRA) Absolute Radio Frequency Channel Number (EARFCN), coarse frequency offset, and cell identification.

In Example 31, the subject matter of Example 26, wherein the information about the one or more infrastructure devices comprises information about a plurality of the one or more infrastructure devices, or information at different times for at least one of the one or more infrastructure devices.

In Example 32, the subject matter of Example 26, wherein the wireless device is comprised within a vehicle.

In Example 33, the subject matter of Example of any of Examples 26-32, wherein the processing means is for comparing navigation path planning information with the geographical information to determine to which one or more infrastructure devices the wireless device is to be handed over.

In Example 34, the subject matter of any of Examples 26-32, further comprising: a transmitting means for forwarding the information about the one or more infrastructure devices to a third wireless device.

In Example 35, the subject matter of Example 26, wherein the receiving means is for receiving from a third wireless device a request to forward to the third wireless device the information about the one or more infrastructure devices.

In Example 36, the subject matter of Example 35, wherein: the request is for a subset of the information about the one or more infrastructure devices, and the transmitting means is for forwarding to the third wireless device the subset.

In Example 37, the subject matter of Example 34, wherein the third wireless device is a base station or a Road Side Unit (RSU).

In Example 38, the subject matter of Example 34, wherein each of the wireless device, second wireless device, and the third wireless device is a base station or road side unit.

In Example 39, the subject matter of Example 26, further comprising: a transmitting means for forwarding the information about the one or more infrastructure devices to a plurality of third wireless devices.

In Example 40, the subject matter of Example 39, wherein the transmitting means is for forwarding the information about the one or more infrastructure devices to the one or more third wireless devices using a broadcasting or multicasting scheme.

In Example 41, the subject matter of Example 26, wherein the second wireless device is a base station or a Road Side Unit (RSU).

In Example 42, the subject matter of Example 26, wherein the information about the one or more infrastructure devices comprises respective validity timers indicating time(s) for which the information about the one or more infrastructure devices is valid.

In Example 43, the subject matter of Example 42, wherein the information about the one or more infrastructure devices comprises respective Received Signal Strength Indicator (RSSI) measurements.

In Example 44, the subject matter of Example 26, wherein the information about the one or more infrastructure devices was received by the second wireless device from a third wireless device.

In Example 45, the subject matter of any of Examples 26-32, wherein the processing means is for processing the information about the one or more infrastructure devices to determine to which beam of an infrastructure device the wireless device is to be handed over.

Example 46 is a central technology trigger device, comprising: a receiving means for receiving user data from one or more wireless devices; a processing means for processing the user data and select a radio access technology to which a selected wireless device is to use for transmission; and a transmitting means for transmitting to the selected wireless device a selection trigger signal indicating the selected radio access technology.

In Example 47, the subject matter of Example 46, wherein the central technology trigger device is located within a infrastructure device and transmits to the selected wireless device directly.

In Example 48, the subject matter of Example 47, wherein the central technology trigger device is located within a infrastructure device and transmits to the selected wireless device via an intervening network.

While the foregoing has been described in conjunction with exemplary aspect, it is understood that the term “exemplary” is merely meant as an example, rather than the best or optimal. Accordingly, the disclosure is intended to cover alternatives, modifications and equivalents, which may be included within the scope of the disclosure.

Although specific aspects have been illustrated and described herein, it will be appreciated by those of ordinary skill in the art that a variety of alternate and/or equivalent implementations may be substituted for the specific aspects shown and described without departing from the scope of the present application. This application is intended to cover any adaptations or variations of the specific aspects discussed herein.

1-25. (canceled)

26. A wireless device, comprising:
a receiver configured to receive, from a second wireless device, information about one or more infrastructure devices having respective coverage areas in which the second wireless device traveled, wherein the information comprises time stamp information and geographical information of the second wireless device when the information was observed; and
a processor configured to process the information of the one or more infrastructure devices to determine to which of the infrastructure devices the wireless device is to be handed over.

27. The wireless device of claim 26, further comprising:
a memory configured to store the information about the one or more infrastructure devices.

28. The wireless device of claim 26, wherein the geographical information is Global Navigation Satellite System (GNSS) information.

29. The wireless device of claim 26, wherein the receiver is configured to receive the information about the one or more infrastructure devices when a distance between the wireless device and the second wireless device is less than a predetermined distance.

30. The wireless device of claim 26, wherein the information about the one or more infrastructure devices comprises cell search information comprising any of cell coarse timing offset, Evolved Universal Terrestrial Radio Access (EUTRA) Absolute Radio Frequency Channel Number (EARFCN), coarse frequency offset, and cell identification.

31. The wireless device of claim 26, wherein the information about the one or more infrastructure devices comprises information about a plurality of one or more infrastructure devices, or information at different times for at least one of the one or more infrastructure devices.

32. The wireless device of claim 26, wherein the wireless device is comprised within a vehicle.

33. The wireless device of claim 26, wherein the processor is configured to compare navigation path planning information with the geographical information to determine to which one or more infrastructure devices to which the wireless device is to be handed over.

34. The wireless device of claim 26, further comprising:
a transmitter configured to forward the information about the one or more infrastructure devices to a third wireless device.

35. The wireless device of claim 26, wherein the receiver is configured to receive from a third wireless device a request to forward to the third wireless device the information about the one or more infrastructure devices.

36. The wireless device of claim 35, wherein:
the request is for a subset of the information about the one or more infrastructure devices, and
the transmitter is configured to forward to the third wireless device the subset.

37. The wireless device of claim 34, wherein the third wireless device is a base station or a Road Side Unit (RSU).

38. The wireless device of claim 34, wherein each of the wireless device, the second wireless device and the third wireless device is a base station or road side unit.

39. The wireless device of claim 26, further comprising:
a transmitter configured to forward the information about the one or more infrastructure devices to a plurality of third wireless devices.

40. The wireless device of claim 14, wherein the transmitter is configured to forward the information about the one or more infrastructure devices to the one or more third wireless devices using a broadcasting or multicasting scheme.

41. The wireless device of claim 26, wherein the second wireless device is a base station or a Road Side Unit (RSU).

42. The wireless device of claim 26, wherein the information about the one or more infrastructure devices comprises respective validity timers indicating time(s) for which the information about the one or more infrastructure devices is valid.

43. The wireless device of claim 42, wherein the information about the one or more infrastructure devices comprises respective Received Signal Strength Indicator (RSSI) measurements.

44. The wireless device of claim 26, wherein the information about the one or more infrastructure devices was received by the second wireless device from a third wireless device.

45. The wireless device of claim 26, wherein the processor is configured to process the information about the one or more infrastructure devices to determine to which beam of a infrastructure device to handover the wireless device.

46. A method of performing wireless communication by a wireless communication device, the method comprising:
receiving, by a receiver of the wireless device, from a second wireless device, information about one or more infrastructure devices having respective coverage areas in which the second wireless device has passed, wherein the information about the infrastructure devices comprises time stamp information and geographical information of the second wireless device when the information was observed; and
processing, by a processor of the wireless communication device, information of the one or more infrastructure devices to determine to which of the infrastructure devices the wireless device is to be handed over.

47. The method of claim 46, further comprising:
forwarding, by a transmitter of the wireless communication device, the information about the one or more infrastructure devices to a third wireless device.

48. A central technology trigger device, comprising:
a receiver configured to receive user data from one or more wireless devices;
a processor configured to process the user data and select a radio access technology to which a selected wireless device is to use for transmission; and
a transmitter configured to transmit to the selected wireless device a selection trigger signal indicating the selected radio access technology.

49. The central technology trigger device of claim 48, wherein the central technology trigger device is located within a infrastructure device and transmits to the selected wireless device directly.

50. The central technology trigger device of claim 49, wherein the central technology trigger device is located within a infrastructure device and transmits to the selected wireless device via an intervening network.
